(19) United States
(12) Patent Application Publication
(10) Pub. No.: US 2022/0172074 A1
(43) Pub. Date: Jun. 2, 2022

(54) VERIFICATION SYSTEM AND VERIFICATION METHOD FOR NEURAL NETWORK ACCELERATOR HARDWARE

(71) Applicant: INDUSTRIAL TECHNOLOGY RESEARCH INSTITUTE, Hsinchu (TW)

(72) Inventors: Shien-Chun LUO, Kaohsiung City (TW); Chien-Ta WU, New Taipei City (TW); Po-Wei CHEN, Xinfeng Township (TW)

(73) Assignee: INDUSTRIAL TECHNOLOGY RESEARCH INSTITUTE, Hsinchu (TW)

(21) Appl. No.: 17/136,991

(22) Filed: Dec. 29, 2020

(30) Foreign Application Priority Data
Nov. 30, 2020 (TW) 109142013

(51) Int. Cl. G06N 3/10; G06N 5/04; G06N 3/04; G06K 9/62; G06N 3/063; G06F 11/34

(52) U.S. Cl. CPC G06N 3/10; G06N 5/04; G06F 11/3457; G06K 9/6288; G06N 3/063; G06N 3/04

(57) ABSTRACT

A verification system and a verification method for a neural network accelerator hardware are provided. The verification system for a neural network accelerator hardware includes a neural network graph compiler and an execution performance estimator. The neural network graph compiler is configured to receive an assumed neural network graph and convert the assumed neural network graph into a suggested inference neural network graph according to a hardware information and an operation mode. The execution performance estimator is configured to receive the suggested inference neural network graph and calculate an estimated performance of the neural network accelerator hardware according to a hardware calculation abstract information of the suggested inference neural network graph.

This application claims the benefit of Taiwan application Serial No. 109142013, filed Nov. 30, 2020, the disclosure of which is incorporated by reference herein in its entirety.

### TECHNICAL FIELD

The disclosure relates in general to a verification system and a verification method for a neural network accelerator hardware.

### BACKGROUND

With the success in computer visual recognition, the application field of neural network (NN) has become wider and wider, and a neural network accelerator hardware is provided to accelerate the neural network hardware.

During the development of conventional neural network software and neural network accelerator hardware, a large amount of training time is required to obtain a real neural network graph and a real parameter set. To verify the execution speed and accuracy of the neural network accelerator hardware, the real neural network graph and the real parameter set obtained through training need to be used at the same time, but the verification will take a large amount of training time. During the development/search process of the neural network software, the research personnel hope that the execution speed and accuracy of the neural network accelerator hardware can be obtained immediately after some of the content of the neural network are finetuned, lest the research personnel might spend a large amount of time and cost in training only to find that the execution speed of the hardware is not satisfactory and needs to be adjusted.

Conventionally, when verifying the neural network accelerator hardware using the real neural network graph and the real parameter set, the verification has a limited completeness and a low coverage, and the edge cases or the corner cases cannot be verified.

### SUMMARY

The disclosure is directed to a verification system and a verification method for a neural network accelerator hardware.

According to one embodiment, a verification system for a neural network accelerator hardware is provided. The verification system for a neural network accelerator hardware includes a neural network graph compiler and an execution performance estimator. The neural network graph compiler is configured to receive an assumed neural network graph and convert the assumed neural network graph into a suggested inference neural network graph according to a hardware information and an operation mode. The execution performance estimator is configured to receive the suggested inference neural network graph and calculate an estimated performance of the neural network accelerator hardware according to a hardware calculation abstract information of the suggested inference neural network graph.

According to another embodiment, a verification method for a neural network accelerator hardware is provided. The verification method for a neural network accelerator hardware includes the following steps. An assumed neural network graph is converted into a suggested inference neural network graph according to a hardware information and an operation mode. An estimated performance of the neural network accelerator hardware is calculated according to a hardware calculation abstract information of the suggested inference neural network graph.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is an input/output diagram of a verification system for a neural network accelerator hardware according to an embodiment.

FIG. 2 is a block diagram of the verification system for the neural network accelerator hardware according to an embodiment.

FIG. 3 is a flowchart of a verification method for the neural nets ork accelerator hardware according to an embodiment.

FIG. 4 is an illustrative example of compiling an assumed neural network graph as a suggested inference neural network graph.

FIG. 5 is a block diagram of the verification system for the neural network accelerator hardware according to another embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

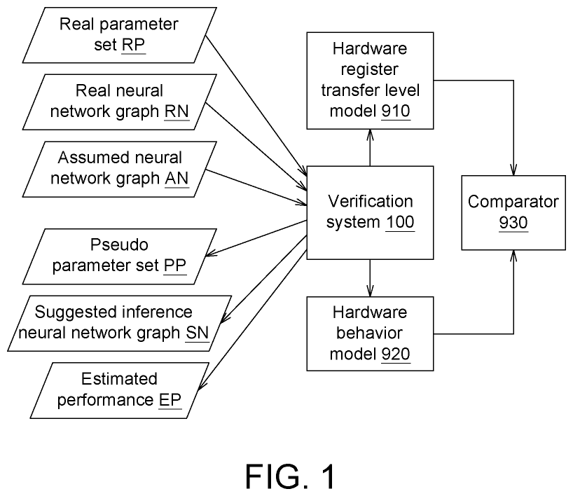

Referring to FIG. 1, an input/output diagram of a verification system 100 for a neural network accelerator hardware according to an embodiment is shown. The verification system 100 verifies the performance and accuracy of a neural network graph operated on the neural network accelerator hardware. In the present embodiment, the real neural network graph RN and the real parameter set RP are inputted to the verification system 100 for the neural network accelerator hardware for verification. Generally speaking, to obtain a stable and convergent real parameter set RP, the real neural network graph RN needs to be trained with a large volume of training data.

The research personnel may fine-tune or modify the real neural network graph RN to obtain an assumed neural network graph AN, which can be a fragment graph. Conventionally, the assumed neural network graph AN needs to be trained with a large volume of training data prior to the determination of whether to verify the assumed neural network graph AN is made. In the verification system 100 of the present embodiment, the assumed neural network graph AN, which has not yet completely trained, can directly be verified even in the absence of a real parameter set. As indicated in FIG. 1, the verification system 100 for the neural network accelerator hardware generates a suggested inference neural network graph SN with respect to the assumed neural network graph AN according to the hardware information and the operation mode. The suggested inference neural network graph SN is a neural network graph to be executed by the hardware and is slightly different from the assumed neural network graph AN. The suggested inference neural network graph SN is adjusted according to the hardware execution model and support computing. When the hardware execution model has several selections, several suggested inference neural network graphs SN corresponding to the selections of the hardware execution model are generated respectively. The suggested inference neural network graph SN can be provided to the research personnel for reference.

Besides, the verification system 100 for the neural network accelerator hardware further generates a pseudo parameter set PP according to the suggested inference neural network graph SN. The pseudo parameter set PP complies with both the graph settings and the hardware specifications. The pseudo parameter set PP is not obtained by training a large volume of training data. With the verification system 100 for a neural network accelerator hardware, the pseudo parameter set PP can be obtained in a few seconds instead of several days to several months of training.

With the suggested inference neural network graph SN and the pseudo parameter set PP, the verification system 100 for the neural network accelerator hardware can calculate an estimated performance EP of the neural network accelerator hardware.

After the pseudo parameter set PP is obtained, two execution results R1 and R2 are respectively obtained by a hardware register transfer level model 910 and a hardware behavior model 920 through simulation and are further compared by a comparator 930 to verify their accuracy.

Thus, the verification system 100 for the neural network accelerator hardware of the present embodiment can directly verify the performance and accuracy of the assumed neural network graph AN operated on the neural network accelerator hardware in the absence of the real parameter set RP. After finetuning the real neural network graph RN to the assumed neural network graph AN, the research personnel can quickly obtain the performance and accuracy of the assumed neural network graph AN operated on the hardware. Therefore, with several times of finetuning and modification performed on the real neural network graph RN within a short period of time, the research personnel can quickly obtain an optimized neural network graph.

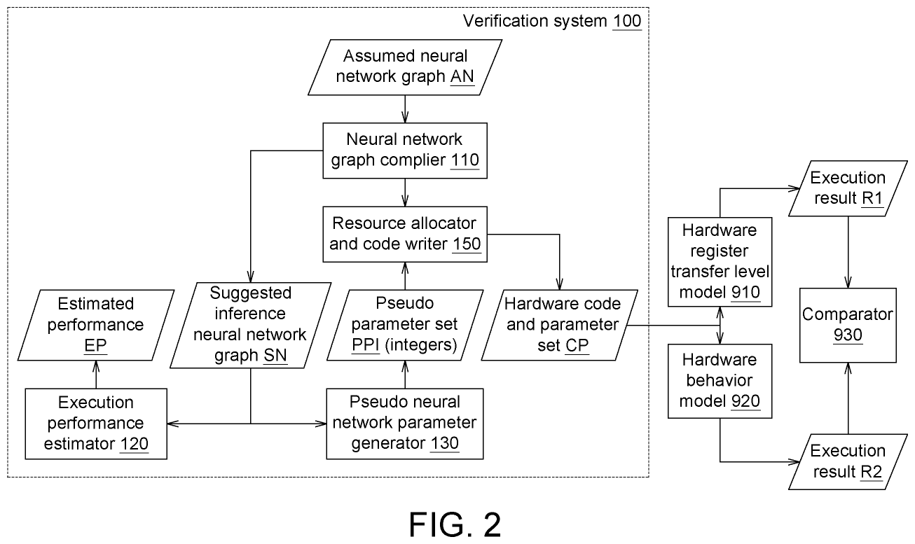

Referring to FIG. 2, a block diagram of the verification system 100 for the neural network accelerator hardware according to an embodiment is shown. The verification system 100 for the neural network accelerator hardware includes a neural network graph compiler 110, an execution performance estimator 120, a pseudo neural network parameter generator 130 and a resource allocator and code writer 150. The verification system 100 for the neural network accelerator hardware can be a software tool, a device expansion card, or a circuit. The neural network graph compiler 110, the execution performance estimator 120, the pseudo neural network parameter generator 130 and/or the resource allocator and code writer 150 are/is a software tool, a device expansion card, a circuit or functions thereof. The software tool the device expansion card, or the circuit can be installed in the computer device for the research personnel to use. After the research personnel obtains the assumed neural network graph AN, the verification system 100 for the neural network accelerator hardware can compile the suggested inference neural network graph SN using the neural network graph compiler 110 and generate a pseudo parameter set PPI using the pseudo neural network parameter generator 130. Thus, the pseudo parameter set PPI can be obtained without a large amount of training, and the performance and accuracy of the assumed neural network graph AN operated on the neural network accelerator hardware can be verified according to the pseudo parameter set PPI. Operations of the above elements are described in an embodiment below.

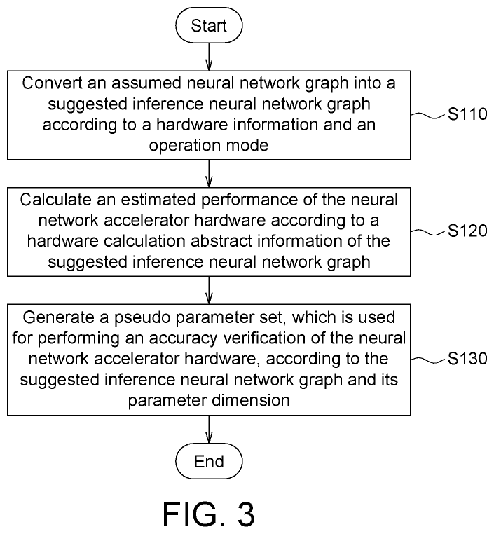

Referring to FIG. 3, a flowchart of a verification method for the neural network accelerator hardware according to an embodiment is shown. In step S110, the assumed neural network graph AN is received and converted into the suggested inference neural network graph SN by the neural network graph compiler 110 according to a hardware information and an operation mode. The suggested inference neural network graph SN can be provided to the research personnel and used as a reference of the graph actually performed on the hardware. The research personnel can modify the real neural network graph RN according to the suggested inference neural network graph SN to obtain a better performance.

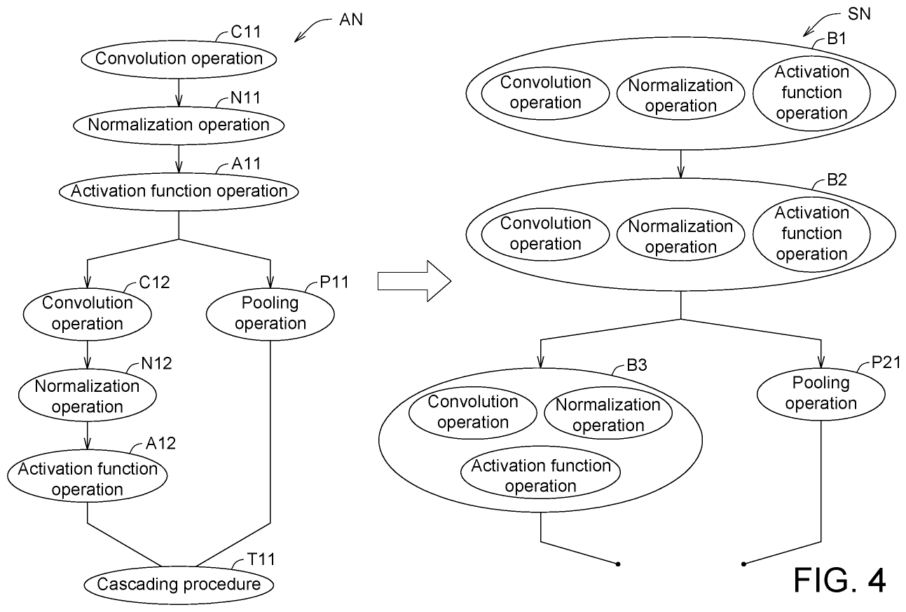

Referring to FIG. 4, an illustrative example of compiling the assumed neural network graph AN as the suggested inference neural network graph SN is shown. If the assumed neural network graph AN contains a convolution operation C11, a normalization operation N11, an activation function operation A11, a convolution operation C12, a normalization operation N12, an activation function operation A12, a pooling operation P11 and a cascading procedure T11. The neural network graph compiler 110 fuses the convolution operation C11, the normalization operation N11, and the activation function operation A11 using a fusion procedure, and further divides the fusion procedure into two fusion procedures B1 and B2 using a partition procedure according to the size of the memory. Similarly, the neural network graph compiler 110 fuses the convolution operation C12, the normalization operation N12, and the activation function operation A12 as a fusion procedure B3 using the fusion procedure. The pooling operation P11 remains unchanged but the designation changes to a pooling operation P21. The cascading procedure T11 is stored as continuous position through allocation features, and then is omitted and is not calculated. The suggested inference neural network graph SN compiled by the neural network graph compiler 110 complies with the specifications and execution modes of the hardware even better.

In step S120, the suggested inference neural network graph SN and its parameter dimension are received by the execution performance estimator 120, and the estimated performance EP of the neural network accelerator hardware is calculated according to a hardware calculation abstract information of the suggested inference neural network graph SN. In the present step, the execution performance estimator 120 simulates the estimated performance EP of the neural network accelerator hardware using a neural network accelerator hardware simulation statistics extraction algorithm. For example, the convolution operation may contain parameters such as 4 dimensions (the height, the width, the depth and the batch number) of the characteristic image, 4 dimensions (the number of filters, the height, the width, and the depth) of the filters or the operation stride. The normalization operation may contain parameters such as linear slope, standard error and mean. The activation function operation may contain digital resolutions required for positive/negative slopes or non-linear functions such as sigmoid function and tanh function. The pooling operation may contain parameters such as input size, pooling kennel size, and computing stride. The hardware calculation abstract information are such as the types, numbers and dimensions of the above parameters, and the cycle count information of the neural network accelerator hardware, that is, the estimated performance EP of the neural network accelerator hardware, can be calculated using the neural network accelerator hardware simulation statistics extraction algorithm according to the types, numbers and dimensions of the above parameters.

In step S130, the pseudo parameter set PPI is generated by the pseudo neural network parameter generator 130 according to the suggested inference neural network graph SN and its parameter dimension. In the example of FIG. 2, the pseudo parameter set PPI is formed of integers. The resource allocator and code writer 150 can receive the suggested inference neural network graph SN and the pseudo parameter set PPI to generate a resource allocation of memory and hardware, and then can generate a hardware code and parameter set CP according to the resource allocation. The resource allocator and code writer 150 outputs the hardware code and parameter set CP to the hardware register transfer level model 910 and the hardware behavior model 920. The hardware register transfer level model 910 and the hardware behavior model 920 respectively obtains two execution results R1 and R2 through simulation and the comparator 930 further compares the execution results R1 and R2 to verify their accuracy.

As disclosed in above embodiments, the neural network graph compiler 110 and the pseudo neural network parameter generator 130 are combined in the present disclosure. Actually, the present disclosure not only combines the functions of the neural network graph compiler 110 and the pseudo neural network parameter generator 130 but further increases two optimization features of expansion as follows: (1). The neural network graph compiler 110 receives the suggested neural network graph SN and its parameter dimension, generates one or more hardware operation mode using one or more neural network accelerator hardware simulation statistics extraction algorithm according to the hardware calculation abstract information of the suggested inference neural network graph SN, and generates parameters respectively complying with the hardware modes. (2). As stated above, the neural network graph compiler 110 generates one or more hardware operation mode, then the execution performance estimator 120 generates the estimated performance, and the pseudo neural network parameter generator 130 generates parameters used to verify the execution result. Based on the two features disclosed above, during the development stage of the neural network algorithm, the verification system 100 of the present disclosure can obtain the performance of one or more hardware in advance. Moreover, the obtained performance of one or more hardware provides a basis of modification for the neural network algorithm, the software/hardware integrated development stage can start earlier, and the backtracking time of design can be greatly reduced.

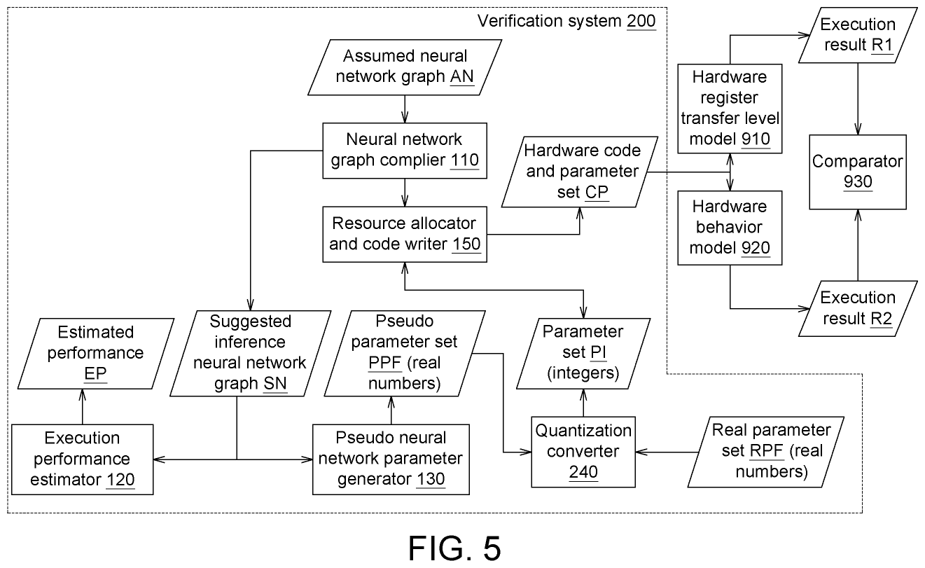

Referring to FIG. 5, a block diagram of the verification system 100 for the neural network accelerator hardware according to another embodiment is shown. In the embodiment of FIG. 5, the assumed neural network graph AN already includes a real parameter set. RPF whose content is formed of real numbers, and the content of the pseudo parameter set PPF generated by the pseudo neural network parameter generator 130 is also formed of real numbers. The quantization converter 240 converts the real-number pseudo parameter set PPF and the real parameter set RPF into an integer parameter set PI through digital quantization according to the suggested inference neural network graph SN and its parameter dimension. The hardware register transfer level model 910 and the hardware behavior model 920 simulates the parameter set PI to obtain two execution result R1 and R2, and the comparator 930 further compares the execution results R1 and R2 to verify their accuracy. In the present step, the comparator 930 verifies whether the execution results R1 and R2 are bit-wise equivalent to assure that the answer obtained through software computing matches that obtained through hardware computing.

As disclosed above, in the absence of the real parameter set, the present disclosure can automatically generate the required pseudo parameter set, generate the formats required under several hardware modes, provide relevant settings of the hardware code and parameter set that can be quickly verified, calculate execution result, and generate hardware performance. The present disclosure can assist the research personnel to quickly generate parameter data for edge cases and corner cases to quickly test hardware functions and complete the coverage of the test. Thus, at the initial design stage, the research personnel can obtain the performance of the neural network graph operated on the hardware for the purpose of optimization adjustment. Besides, the technology of the present disclosure can simultaneously serve a diversity of purposes such as the verification of digitalization error (also referred as quantization error) and hardware performance of the neural network graph operated on exclusive hardware, the prediction of execution speed, and assistance in the common debugging of hardware and software.

It Anil be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A verification system for a neural network accelerator hardware, comprising:
a neural network graph compiler configured to receive an assumed neural network graph and convert the assumed neural network graph into a suggested inference neural network graph according to a hardware information and an operation mode; and
an execution performance estimator configured to receive the suggested inference neural network graph and calculate an estimated performance of the neural network accelerator hardware according to a hardware calculation abstract information of the suggested inference neural network graph.

2. The verification system for the neural network accelerator hardware according to claim 1, further comprising:
a pseudo neural network parameter configured to generate a pseudo parameter set according to the suggested inference neural network graph and its parameter dimension, wherein the pseudo parameter set is used for performing an accuracy verification of the neural network accelerator hardware.

3. The verification system for the neural network accelerator hardware according to claim 2, wherein in the accuracy verification, whether two execution results are bit-wise equivalent is verified.

4. The verification system for the neural network accelerator hardware according to claim 2, wherein content of the pseudo parameter set is formed of integers or real numbers.

5. The verification system for the neural network accelerator hardware according to claim 1, wherein the neural network graph compiler converts the assumed neural network graph into the suggested inference neural network graph using a fusion procedure and a partition procedure.

6. The verification system for the neural network accelerator hardware according to claim 1, wherein the assumed neural network graph has not yet completely trained.

7. The verification system for the neural network accelerator hardware according to claim 1, wherein the execution performance estimator obtains the estimated performance of the neural network accelerator hardware through simulation using a neural network accelerator hardware simulation statistics extraction algorithm.

8. The verification system for the neural network accelerator hardware according to claim 1, wherein the assumed neural network graph is a fragment graph.

9. The verification system for the neural network accelerator hardware according to claim 1, wherein the estimated performance is a cycle count information.

10. A verification method for a neural network accelerator hardware, comprising:
converting an assumed neural network graph into a suggested inference neural network graph according to a hardware information and an operation mode; and
calculating an estimated performance of the neural network accelerator hardware according to a hardware calculation abstract information of the suggested inference neural network graph.

11. The verification method for the neural network accelerator hardware according to claim 10, further comprising:
generating a pseudo parameter set according to the suggested inference neural network graph and its parameter dimension, wherein the pseudo parameter set is used for performing an accuracy verification of the neural network accelerator hardware.

12. The verification method for the neural network accelerator hardware according to claim 11, wherein in the accuracy verification, whether two execution results are bit-wise equivalent is verified.

13. The verification method for the neural network accelerator hardware according to claim 11, wherein content of the pseudo parameter set is formed of integers or real numbers.

14. The verification method for the neural network accelerator hardware according to claim 10, wherein the neural network graph compiler converts the assumed neural network graph into the suggested inference neural network graph using a fusion procedure and a partition procedure.

15. The verification method for the neural network accelerator hardware according to claim 10, wherein the assumed neural network graph has not yet completely trained.

16. The verification method for the neural network accelerator hardware according to claim 10, wherein the execution performance estimator obtains the estimated performance of the neural network accelerator hardware through simulation using a neural network accelerator hardware simulation statistics extraction algorithm.

17. The verification method for the neural network accelerator hardware according to claim 10, wherein the assumed neural network graph is a fragment graph.

18. The verification method for the neural network accelerator hardware according to claim 10, wherein the estimated performance is a cycle count information.
